(19) United States
(12) Patent Application Publication
(10) Pub. No.: US 2015/0225878 A1
(43) Pub. Date: Aug. 13, 2015

(54) Cellular Structures

(71) Applicant: Gosakan Aravamudan, Bangalore (IN)

(72) Inventor: Gosakan Aravamudan, Bangalore (IN)

(21) Appl. No.: 14/616,654

(22) Filed: Feb. 7, 2015

(30) Foreign Application Priority Data
Feb. 7, 2014 (IN) 578/CHE/2014

(51) Int. Cl. D01D 5/42; B32B 38/00

(52) U.S. Cl. CPC D01D 5/426; B32B 38/00; B32B 38/0004; B32B 2305/10; B32B 2311/24; B32B 2315/08

(57) ABSTRACT

A metal fiber composite cellular structure includes cell walls composed of metal foils. At least two of the cell walls of each cell of the metal fiber composite cellular structure further includes a continuous fiber roving coated in an adhesive resin adhered to the metal foil, which creates continuous fiber adhesive node bond lines. The continuous fiber adhesive node bond lines improve compressive properties and shear properties of the metal fiber composite cellular structure without a weight penalty when used to manufacture sandwich structures.

### CROSS REFERENCE TO RELATED APPLICATIONS

This application claims priority to and the benefit of provisional patent application number 578/CHE/2014 titled “Cellular Structures”, filed in the Indian Patent Office on Feb. 7, 2014, and non-provisional patent application number 578/CHE/2014 titled “Cellular Structures”, filed in the Indian Patent Office on Feb. 7, 2015. The specifications of the above referenced patent applications are incorporated herein by reference in their entirety.

### BACKGROUND

The method disclosed herein, in general, relates to manufacturing cellular structures. More particularly, the method disclosed herein relates to manufacturing a metal fiber composite cellular structure.

Conventionally, cellular structures are made from a homogeneous web of materials. The homogeneous web provides a set of properties required for a particular application. For example, honeycomb structures made entirely from aluminum are extensively used in lightweight applications. Many applications require specialized cellular structures, for example, honeycomb cellular structures comprising honeycomb walls with more than one type of fiber to achieve properties that an application requires. For example, the required property could be additional compressive strength and improved shear strength. However, there are no heterogeneous cellular structures available in the market today that serve the needs of the above mentioned applications.

Hence, there is a long felt but unresolved need for a metal fiber composite cellular structure with improved compressive properties and improved shear properties, without a weight penalty when used to manufacture sandwich structures.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The heterogeneous metal fiber composite cellular structure disclosed herein addresses the above mentioned need for improved compressive properties and improved shear properties, without a weight penalty when used to manufacture sandwich structures. The metal fiber composite cellular structure disclosed herein comprises cell walls composed of metal foils. The metal foil is, for example, an aluminum foil with a predefined thickness, for example, in the range of about 10 microns to about 200 microns. Each of at least two of the cell walls of the metal fiber composite cellular structure further comprises a fiber roving coated in an adhesive resin adhered to the metal foil, thereby creating continuous fiber adhesive node bond lines. The fiber roving is, for example, a glass fiber roving. The continuous fiber adhesive node bond lines improve the compressive properties and the shear properties of the metal fiber composite cellular structure without a weight penalty when used to manufacture sandwich structures.

Also, disclosed herein is a method for manufacturing a metal fiber composite cellular structure. Metal foil sheets are stacked one on top of another. Each alternate stacked metal foil sheet comprises continuous fiber adhesive node bond lines that are offset between layers of the stacked metal foil sheets. The offset is, for example, about half the width of the cell size of the metal fiber composite cellular structure. The adhesive in the continuous fiber adhesive node bond lines is cured by applying heat to the stacked metal foil sheets in a thermal chamber to attach the stacked metal foil sheets. The stacked metal foil sheets are cut into strips. Each strip is then expanded to create the metal fiber composite cellular structure.

Also, disclosed herein is an embodiment of the method for manufacturing a metal fiber composite cellular structure. Two continuous metal foil sheets originating from a first roller and a second roller are stacked onto a third roller. Continuous fiber adhesive node bond lines are applied to each of the two metal foil sheets. The continuous fiber adhesive node bond lines from the first roller and the second roller are offset with respect to each other, for example, by about half the width of the cell size of the metal fiber composite cellular structure. The adhesive in the continuous fiber adhesive node bond lines is cured by applying heat to the stacked metal foil sheets in a thermal chamber to attach the stacked metal foil sheets. The stacked metal foil sheets are cut into strips. Each strip is then expanded to create the metal fiber composite cellular structure.

Depending on the type of fiber used, for example, glass, or aramid, or carbon, the continuous fiber adhesive node bond lines provide additional compressive strength and improved shear strength without a weight penalty.

### BRIEF DESCRIPTION OF THE DRAWINGS

The foregoing summary, as well as the following detailed description of an embodiment of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a metal fiber composite cellular structure.

FIG. 2 exemplarily illustrates an apparatus for manufacturing a metal fiber composite cellular structure.

FIG. 3 illustrates a method for manufacturing a metal fiber composite cellular structure.

FIG. 4 exemplarily illustrates an embodiment of the apparatus for manufacturing a metal fiber composite cellular structure.

FIG. 5 illustrates an embodiment of the method for manufacturing a metal fiber composite cellular structure.

### DETAILED DESCRIPTION OF THE INVENTION

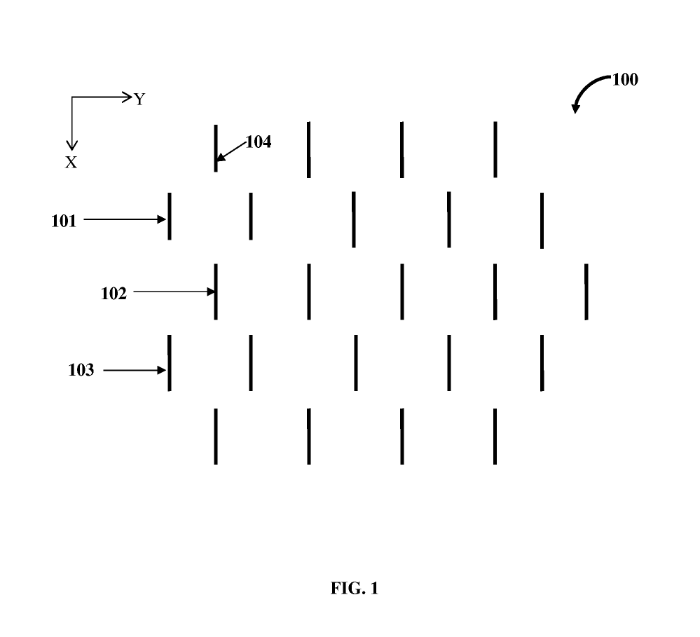

FIG. 1 exemplarily illustrates a metal fiber composite cellular structure 100. The metal fiber composite cellular structure 100 disclosed herein comprises cell walls 101, 102, and 103. The cell walls 101, 102, and 103 of the metal fiber composite cellular structure 100 comprise metal foils. The metal foil is, for example, an aluminum foil with a predefined thickness, for example, in the range of about 10 microns to about 200 microns. Each of at least two of the cell walls 102 and 103 of the metal fiber composite cellular structure 100 further comprises a fiber roving coated in an adhesive resin adhered to the metal foil, thereby creating continuous fiber adhesive node bond lines 104. As used herein, “continuous fiber adhesive node bond lines” refer to continuous fibers in an adhesive matrix positioned at nodes of the metal fiber composite cellular structure 100. The adhesive resin is, for example, an epoxy resin, a bismaleimide resin, or a phenolic resin. The fiber roving is, for example, a glass fiber roving. The continuous fiber adhesive node bond lines 104 provide a secondary function of improving compressive properties and shear properties of the metal fiber composite cellular structure 100 without a weight penalty when used to manufacture sandwich structures.

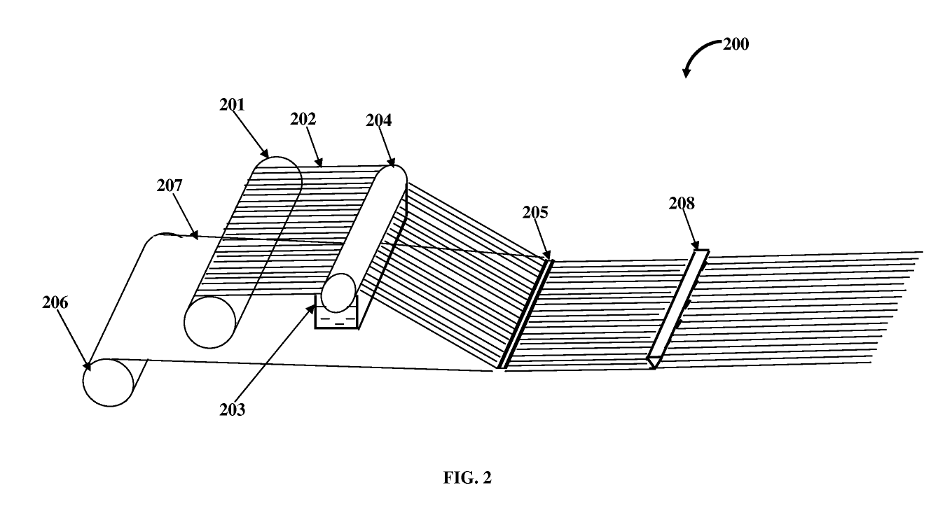

FIG. 2 exemplarily illustrates an apparatus 200 for manufacturing a metal fiber composite cellular structure 100 exemplarily illustrated in FIG. 1. The apparatus 200 disclosed herein comprises a rovings roller 201, a roller 204 operably positioned within an adhesive tank 203, guide eyes 205, a metal foil roller 206, and a cutter 208. The adhesive tank 203 contains an adhesive resin.

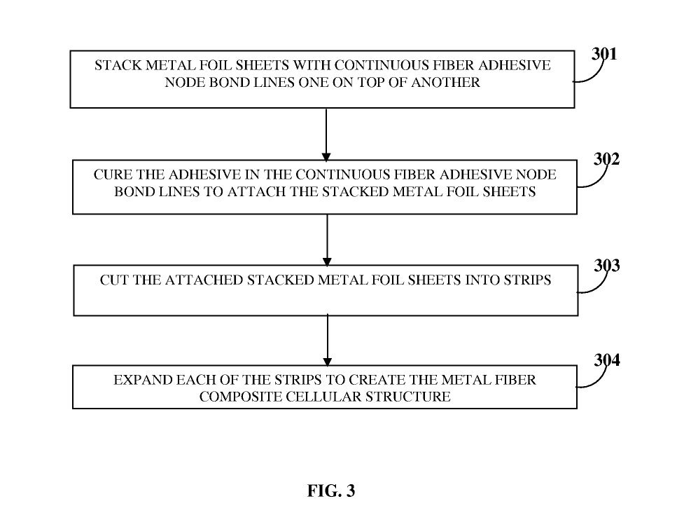

FIG. 3 illustrates a method for manufacturing a metal fiber composite cellular structure 100 exemplarily illustrated in FIG. 1, using the apparatus 200 exemplarily illustrated in FIG. 2. Continuous glass fiber rovings 202 from the rovings roller 201 are dipped in the adhesive tank 203 through the roller 204 operably positioned in the adhesive tank 203, which coats the glass fiber rovings 202 with the adhesive resin contained in the adhesive tank 203. The excess adhesive is squeezed out and then laid by the guide eyes 205 on metal foil sheets 207 originating from the metal foil roller 206. The metal foil sheets 207 are stacked 301 one on top of another. Each alternate stacked metal foil sheet 207 further comprises continuous fiber adhesive node bond lines 104 exemplarily illustrated in FIG. 1, that are offset between layers of the metal foil sheets 207. The offset is, for example, about half the width of the cell size of the metal fiber composite cellular structure 100. The adhesive in the continuous fiber adhesive node bond lines 104 is cured 302 by heat application in a thermal chamber (not shown) to attach the stacked metal foil sheets. The stacked metal foil sheets are cut 303 into strips using the cutter 208. Each strip is then expanded 304 into cellular structures to create the metal fiber composite cellular structure 100.

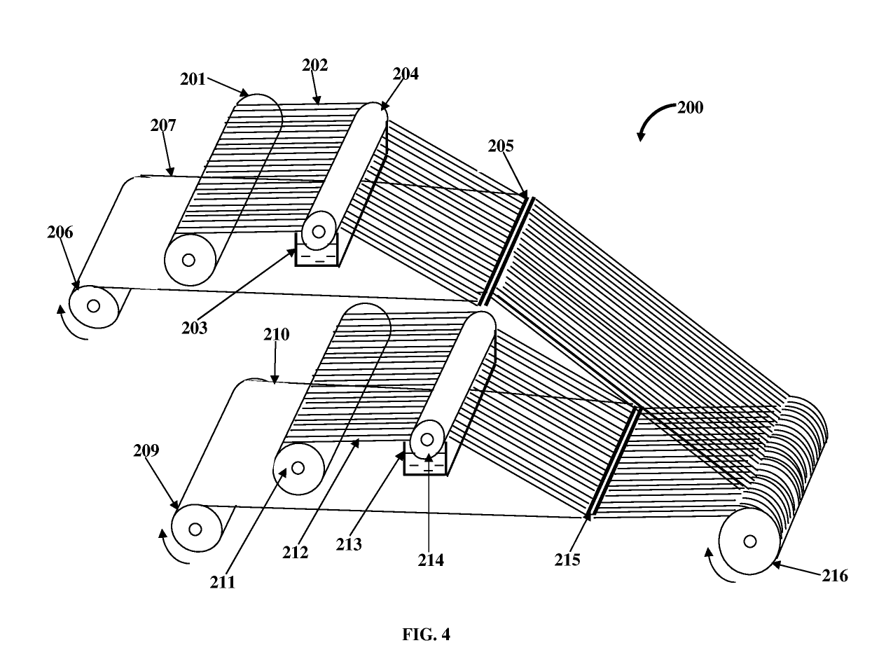

FIG. 4 exemplarily illustrates an embodiment of the apparatus 200 for manufacturing a metal fiber composite cellular structure 100 exemplarily illustrated in FIG. 1. In this embodiment, the apparatus 200 disclosed herein comprises rovings rollers 201 and 211, rollers 204 and 214 operably positioned within adhesive tanks 203 and 213 respectively, guide eyes 205 and 215, metal foil rollers 206 and 209, and another roller 216. The adhesive tanks 203 and 213 contain adhesive resins.

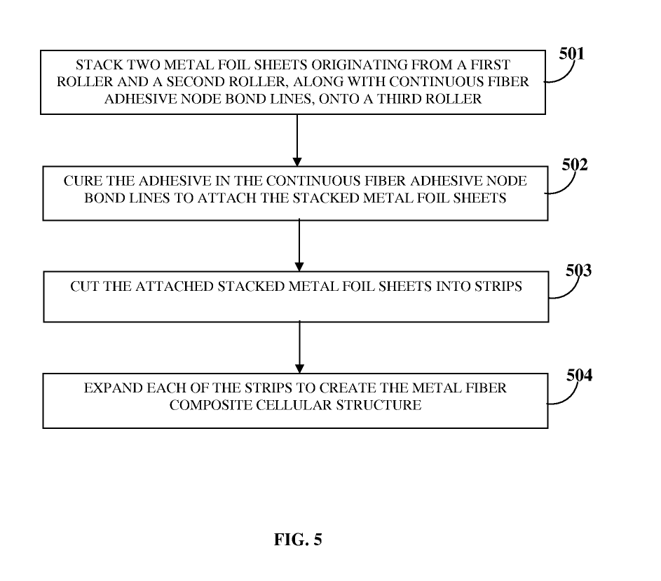

FIG. 5 illustrates an embodiment of the method for manufacturing a metal fiber composite cellular structure 100 exemplarily illustrated in FIG. 1, using the embodiment of the apparatus 200 exemplarily illustrated in FIG. 4. Two continuous metal foil sheets 207 and 210 originating from a first metal foil roller 206 and a second metal foil roller 209 are rolled on one top of another and thereby stacked 501 onto a third roller 216 via the guide eyes 205 and 215. Continuous glass fiber rovings 202 and 212 are dipped in the adhesive tanks 203 and 213 through the rollers 204 and 214 operably positioned in the adhesive tanks 203 and 213 respectively, which coat the glass fiber rovings 202 and 212 with the adhesive resins contained in the adhesive tanks 203 and 213 respectively. The excess adhesive from the glass fiber rovings 202 and 212 is squeezed out, thereby forming continuous fiber adhesive node bond lines 104 exemplarily illustrated in FIG. 1. The continuous fiber adhesive node bond lines 104 are applied to each of the two metal foil sheets 207 and 210. Continuous fiber adhesive node bond lines 104 from the first rovings roller 201 and the second rovings roller 211 are offset with respect to each other, for example, by about half the width of the cell size of the metal fiber composite cellular structure 100. The adhesive in the continuous fiber adhesive node bond lines 104 is cured 502 by heat application in a thermal chamber (not shown) to attach the stacked metal foil sheets. The attached, stacked metal foil sheets are cut 503 into strips using the cutter 208 exemplarily illustrated in FIG. 2. Each strip is then expanded 504 into cellular structures to create the metal fiber composite cellular structure 100.

In an example, 33 tex glass fibers dipped in a heat curable epoxy resin were used as the continuous fiber adhesive node bond lines 104. These continuous fiber adhesive node bond lines 104 were then applied on aluminum metal foil sheets 207 and 210, each having a thickness of, for example, about 0.001 inch. The aluminum metal foil sheets 207 and 210 along with the deposited continuous fiber adhesive node bond lines 104 were cut into individual sheets of, for example, about 1 meter length×1 meter width. The cut metal foil sheets are successively offset, for example, by about 3 millimeter (mm) and stacked on top of each other. The stacked metal foil sheets were pressed and heated, for example, to about 120° Celsius to cure the epoxy resin. Strips were then cut from this stack and expanded to form a honeycomb cellular structure. For a comparable base reference, another honeycomb cellular structure was created with an identical material, but with an epoxy adhesive replacing the continuous fiber adhesive node bond lines 104. In the comparable base reference, there is no 33 tex glass fibers present in the cellular structure, while all other elements remain the same. For the comparable base reference, the stabilized compressive strength was measured to be, for example, about 500 pounds per square inch (psi) and the plate shear strength in the L direction was, for example, about 250 psi. For the honeycomb cellular structure with the continuous fiber adhesive node bond lines 104, the stabilized compressive strength was, for example, about 575 psi and the plate shear strength in the L direction was, for example, about 300 psi. This results, for example, in an about 15% to about 20% improvement in the compressive strength and the shear strength with less than about 5% weight penalty as a result of the additional 33 tex.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A metal fiber composite cellular structure comprising:
cell walls, each of said cell walls comprising a metal foil;
each of at least two of said cell walls further comprising a fiber roving coated in an adhesive resin adhered to said metal foil of said each of said at least two of said cell walls, thereby creating continuous fiber adhesive node bond lines, wherein said continuous fiber adhesive node bond lines improve compressive properties and shear properties of said metal fiber composite cellular structure without a weight penalty when used to manufacture sandwich structures.

2. The metal fiber composite cellular structure of claim 1, wherein said metal foil is an aluminum foil with a predefined thickness in a range of about 10 microns to about 200 microns.

3. The metal fiber composite cellular structure of claim 1, wherein said fiber roving is a glass fiber roving.

4. A method for manufacturing a metal fiber composite cellular structure, said method comprising:
stacking metal foil sheets one on top of another, wherein each alternate one of said stacked metal foil sheets comprises continuous fiber adhesive node bond lines that are offset between layers of said stacked metal foil sheets;
curing an adhesive in said continuous fiber adhesive node bond lines of said each alternate one of said stacked metal foil sheets to attach said stacked metal foil sheets;
cutting said attached stacked metal foil sheets into strips; and
expanding each of said strips to create said metal fiber composite cellular structure.

5. A method for manufacturing a metal fiber composite cellular structure, said method comprising:
stacking two metal foil sheets originating from a first roller and a second roller onto a third roller, wherein continuous fiber adhesive node bond lines are applied to each of said two metal foil sheets, and wherein said continuous fiber adhesive node bond lines from said first roller and said second roller are offset with respect to each other;
curing an adhesive in said continuous fiber adhesive node bond lines to attach said stacked metal foil sheets;
cutting said attached stacked metal foil sheets into strips; and
expanding each of said strips to create said metal fiber composite cellular structure.
